(19) United States
(12) Patent Application Publication
(10) Pub. No.: US 2025/0272633 A1
(43) Pub. Date: Aug. 28, 2025

(54) ALLOCATION OF EXECUTION INFORMATION FOR A BIG DATA WORKLOAD BATCH PROCESSING JOB EXECUTED IN CLOUD ENVIRONMENT BY TRANSIENT INFRASTUCTURE

(71) Applicants: Aby Korah, South Windsor, CT (US); Mohan Subramaniam, Southington, CT (US); James A. Madison, Windsor, CT (US); Mike Gagne, Hartford, CT (US)

(72) Inventors: Aby Korah, South Windsor, CT (US); Mohan Subramaniam, Southington, CT (US); James A. Madison, Windsor, CT (US); Mike Gagne, Hartford, CT (US)

(21) Appl. No.: 18/584,325

(22) Filed: Feb. 22, 2024

(51) Int. Cl. G06Q 10/0631; G06Q 10/04; G06Q 30/0283

(52) U.S. Cl. CPC G06Q 10/06313; G06Q 10/04; G06Q 30/0284

(57) ABSTRACT

A transient infrastructure management platform may establish a transient infrastructure in a cloud computing environment, trigger execution of a big data workload batch processing job, run a master script, and automatically shut down the transient infrastructure and delete associated resources. A cloud computing allocation tool may receive information from an enterprise structure data store containing electronic records (with each record including hierarchy information about organizations within an enterprise). The cloud computing allocation tool may also receive execution information associated with the big data workload batch processing job that was executed by the cloud computing environment for the enterprise. Based on the received execution information, hierarchy information about organizations within the enterprise, and allocation rules, the cloud computing allocation tool may automatically calculate allocation amounts for the execution information among a plurality of the organizations.

### BACKGROUND

An enterprise may utilize a cloud computing environment to perform various functions. For example, a business might execute applications on the cloud in connection with Human Resources (“HR”) functions, accounting tasks, customer service, Information Technology (“IT”) tools, etc. The cloud service provider then typically charges the enterprise based on the amount of computing resources that were needed to run the applications (e.g., memory utilization, database storage, etc.). As a result, an enterprise may be interested in structuring applications in ways that reduce the overall cost of cloud execution. It is known that a cloud provider may implement mechanisms that have various tasks self-start and self-stop (to reduce the use of computing resources). However, these mechanisms are generic in nature because they need to work for everything from small businesses to extremely large multi-national corporations. Because of this the mechanisms are limited to standard things such as wall clock time or event firing conditions.

Moreover, an enterprise may be comprised of a substantial number of organizations (e.g., associated with various departments, lines of business, product types, etc.). When costs are shared on an enterprise, it can be difficult to encourage each organization to create efficient applications. It is known that a cloud service provider can use high-level tags to itemize costs at a large granular level, this may not be sufficient to encourage efficiency. Moreover, many types of tasks are best handled using big data workload batch processing which might not support tagging at a fine granular level.

Systems and methods for improvements in processes relating to the allocation of cloud execution amounts, while avoiding unnecessary burdens on computer processing resource utilization, would be desirable.

### SUMMARY OF THE INVENTION

According to some embodiments, systems, methods, apparatus, computer program code and means may provide ways to facilitate allocations for an enterprise. A transient infrastructure management platform may establish a transient infrastructure in a cloud computing environment, trigger execution of a big data workload batch processing job, run a master script, and automatically shut down the transient infrastructure and delete associated resources. A cloud computing allocation tool may receive information from an enterprise structure data store containing electronic records (with each record including hierarchy information about organizations within an enterprise). The cloud computing allocation tool may also receive execution information associated with the big data workload batch processing job that was executed by the cloud computing environment for the enterprise. Based on the received execution information, hierarchy information about organizations within the enterprise, and allocation rules, the cloud computing allocation tool may automatically calculate allocation amounts for the execution information among a plurality of the organizations.

Some embodiments provide means for establishing, by a transient infrastructure management platform, a transient infrastructure in the cloud computing environment; triggering execution of a big data workload batch processing job; means for running, by the transient infrastructure management platform, a master script; means for automatically shutting down the transient infrastructure and deleting associated resources; means for retrieving, by a computer processor of a cloud computing allocation tool, hierarchy information from an enterprise structure data store containing electronic records, each record including hierarchy information about organizations within the enterprise; means for receiving execution information associated with the big data workload batch processing job that was executed by the cloud computing environment for the enterprise; based on the received execution information, hierarchy information about organizations within the enterprise, and allocation rules, means for automatically calculating allocation amounts for the execution information among a plurality of the organizations; and means for transmitting, via a communication port coupled to the cloud computing allocation tool, data to provide a graphical interactive user interface display via a distributed communication network, the graphical interactive user interface including the allocation amounts.

A technical effect of some embodiments of the invention is an improved and computerized method relating to the allocation of cloud execution amounts for an enterprise while avoiding unnecessary burdens on computer processing resource utilization. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is an enterprise hierarchy structure according to some embodiments.

FIG. 2 illustrates a system diagram in accordance with some embodiments.

FIG. 3 illustrates a method according to some embodiments of the present invention.

FIG. 4 is an illustration of allocation in accordance with some embodiments.

FIG. 5A is an allocation dashboard display according to some embodiments.

FG. 5B is a transient cluster dashboard display according to some embodiments.

FIG. 6 is an allocation system in accordance with some embodiments.

FIG. 7 is a high-level information flow overview according to some embodiments.

FIG. 8 is a more detailed method in accordance with some embodiments.

FIGS. 9 through 11 are allocation lookup tables according to some embodiments.

FIGS. 12 through 14 are allocation output tables in accordance with some embodiments.

FIG. 15 is an allocation tagging method according to some embodiments.

FIG. 16 is an allocation variance method in accordance with some embodiments.

FIG. 17 is an allocation prediction method according to some embodiments.

FIG. 18 is a block diagram of an apparatus or platform in accordance with some embodiments of the present invention.

FIG. 19 is a tabular portion of a cloud allocation data store according to some embodiments.

FIG. 20 is an operator or administrator display in accordance with some embodiments.

FIG. 21 illustrates a handheld tablet according to some embodiments described herein.

### DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data availability, consistency, and analytics associated with cloud computing allocation amounts. The present invention is directed to more than merely a computer implementation of a routine or conventional activity previously known in the industry as it provides a specific advancement in the area of electronic record availability, consistency, and analysis by providing improvements in the operation of a computer system that uses a combination of features to ensure data quality. The present invention provides improvement beyond a mere generic computer implementation as it involves the novel ordered combination of system elements and processes to provide improvements in the speed at which such data can be made available and consistent results. Some embodiments of the present invention are directed to a system adapted to automatically validate information, analyze electronic records, aggregate data from multiple sources, determine appropriate allocations, etc. Moreover, communication links and messages may be automatically established (e.g., to provide alerts to appropriate parties within an organization), aggregated, formatted, exchanged, etc. to improve network performance (e.g., by reducing an amount of network messaging bandwidth and/or storage required to support information collection, allocation, analysis, and distribution).

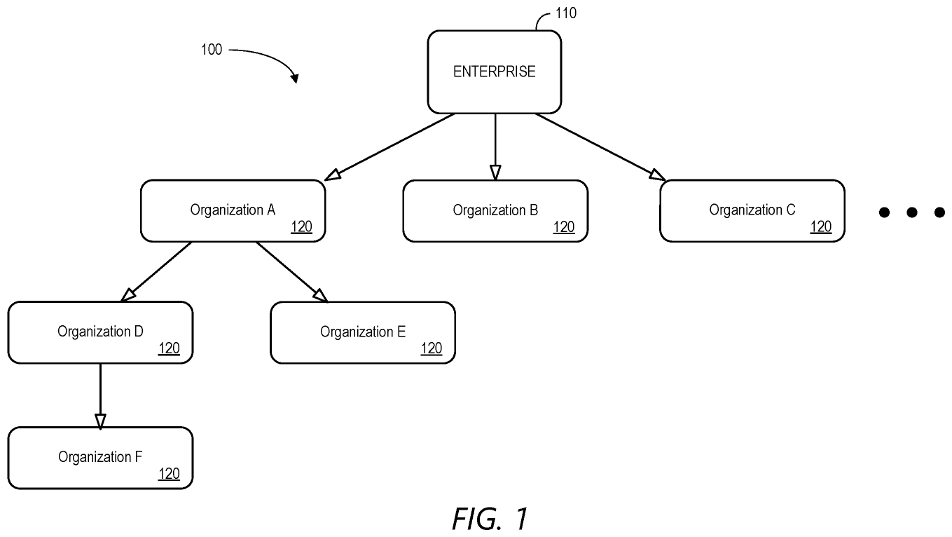

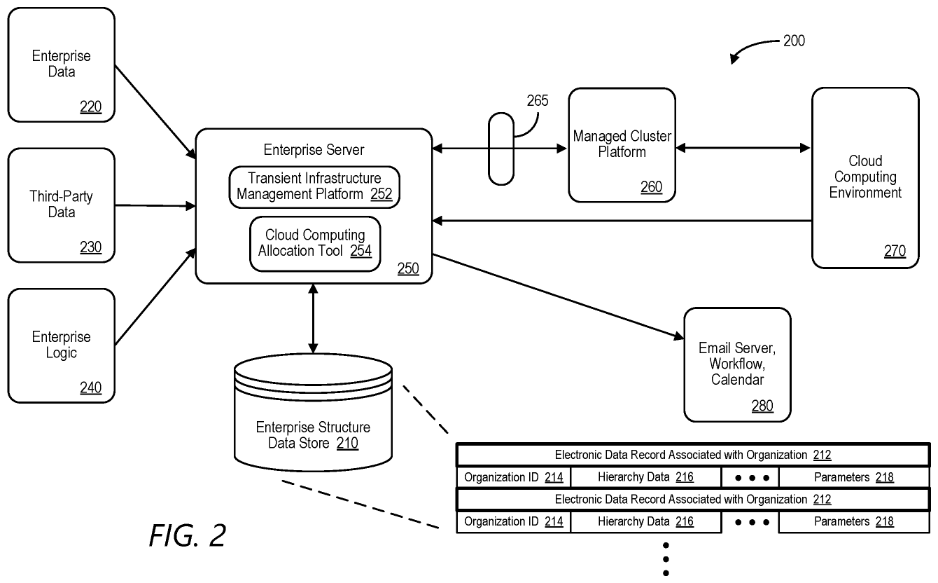

An enterprise may include a number of sub-organizations. For example, FIG. 1 is an enterprise hierarchy structure 100 according to some embodiments. The structure 100 includes the enterprise 110 itself arranged in a hierarchy of a number of organizations 120 (e.g., organizations A, B, and C are directly below the highest level of the enterprise 110, organizations D and E are directly below organization A, etc.). As used herein the term “organizations” may refer to, for example, lines of business, departments, teams, divisions, system structures (e.g., associated with IT or HR structures), etc. FIG. 2 is a high-level block diagram of a system 200 that may leverage such structural information according to some embodiments of the present invention. In particular, the system 200 includes an enterprise server 250 that may access information in an enterprise structure data store 210 (e.g., storing a set of electronic records representing organizations with the enterprise). The enterprise structure data store 210 may include data based on account, application, and/or user lookup tables, organization charts and plans, etc. The enterprise server 250 may include a transient infrastructure management platform 252 and a cloud computing allocation tool 254 that retrieve information from other data stores or sources (e.g., enterprise data 220 about a business, third-party data 230, and enterprise logic 240 defining allocation rules, including ML or artificial intelligence algorithms and/or models, to the electronic records). The enterprise server 250 may also exchange information with a remote managed cluster platform 260 (e.g., via communication port 265 that might include a firewall) to utilize a cloud computing environment 270 (e.g., such as AMAZON® Web Services (“AWS”) or GOOGLE® Cloud Platform, MICROSOFT® Azure™, etc.). According to some embodiments, the enterprise server 250 may facilitate the display of information associated with allocations via one or more remote computers (e.g., to enable a manual review of dashboards) and/or automatically establish a communication link with an email server, workflow and/or calendar 280. Note that the enterprise server 250 and/or any of the other devices and methods described herein might be associated with a cloud-based environment and/or a third-party, such as a vendor that performs a service for an enterprise.

The enterprise server 250 and/or the other elements of the system 200 might be, for example, associated with a Personal Computer (“PC”), laptop computer, smartphone, an enterprise server, a server farm, and/or a data store or similar storage devices. According to some embodiments, an “automated” enterprise server 250 (and/or other elements of the system 200) may facilitate updates of electronic records in the enterprise structure data store 210. As used herein, the term “automated” may refer to, for example, actions that can be performed with little (or no) intervention by a human.

As used herein, devices, including those associated with the enterprise server 250 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The enterprise server 250 may store information into and/or retrieve information from the enterprise structure data store 210. The enterprise structure data store 210 might, for example, store electronic records representing a plurality of potential organizations 212, each electronic record 212 having an organization identifier 214, hierarchy data 216, and other structural parameters 218 (e.g., a lookup table mapping of application names to various organizations and/or users). The system 200 may also contain information about prior and current interactions with entities, including those associated with remote evaluation devices. The enterprise structure data store 210 may be locally stored or reside remote from the enterprise server 250. As will be described further below, the enterprise structure data store 210 may be used by the enterprise server 250 in connection with an interactive user interface to provide information about cloud allocation amounts. Such information may, for example, help encourage organizations to create more efficient cloud applications. Although a single enterprise server 250 is shown in FIG. 2, any number of such devices may be included. Moreover, various devices described herein might be combined according to embodiments of the present invention.

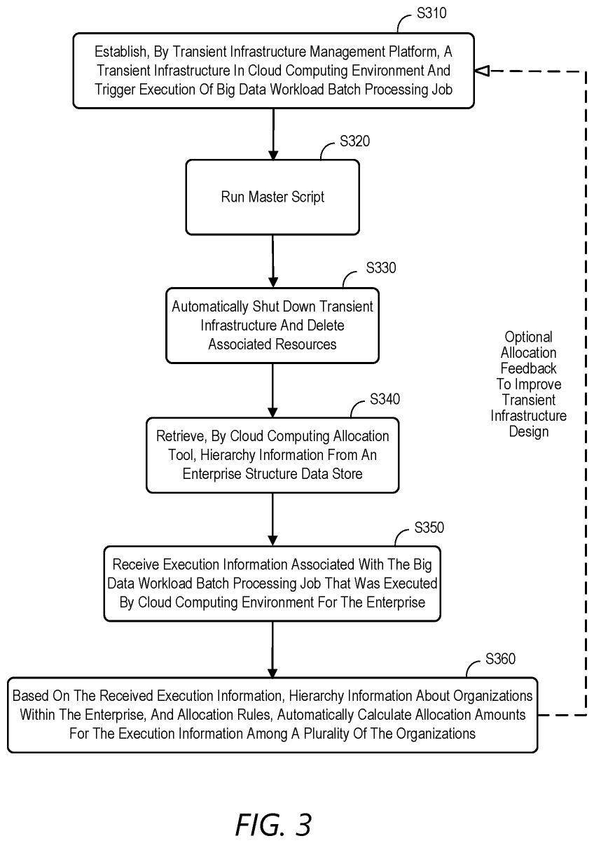

FIG. 3 illustrates a method that might be performed, for example, by some or all of the elements of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a transient infrastructure management platform may establish a transient infrastructure in a cloud computing environment trigger execution of a big data workload batch processing job. As used herein, the phrase “transient infrastructure” may refer to, for example, a cloud computing cluster or set of computing/data resources that work together to perform a task. The big data workload batch processing job might be associated with, for example, a managed cluster platform (e.g., AMAZON® Elastic MapReduce™) or a managed, cloud-based data storage and analysis platform (e.g., SNOWFLAKE®). Other examples include an infrastructure support ticketing system, a third-party data service, an on-premises platform, an enterprise cloud data management and data integration platform (e.g., INFORMATICA®), an end-to-end data management platform, etc.

At S320, the transient infrastructure management platform may run a master script, automatically shut down the transient infrastructure, and delete associated resources. At S330, a computer processor of a cloud computing allocation tool may retrieve hierarchy information from an enterprise structure data store. The enterprise structure data store may, for example, contain electronic records that each include hierarchy information about organizations within the enterprise. According to some embodiments, the hierarchy information may be generated via a Lightweight Directory Access Protocol (“LDAP”) analysis.

At S340, execution information associated with the big data workload batch processing job (executed by the cloud computing environment for the enterprise) may be received. Based on the received execution information, hierarchy information about organizations within the enterprise, and allocation rules, at S350 the system may automatically calculate allocation amounts for the execution information among a plurality of the organizations. According to some embodiments, the execution information includes a financial cost and the computed allocation amounts comprise allocated financial costs. According to some embodiments, the allocation rules may be associated with an account identifier, an application identifier, a user identifier, etc.

At S360, a communication port coupled to the cloud computing allocation tool may be used to transmit data and provide a graphical interactive user interface display via a distributed communication network (with the graphical interactive user interface including the allocation amounts). According to some embodiments, the system is further to display a combined financial cost for a subset of the organizations (e.g., a number of organizations associated with a line of business), a period of time (e.g., monthly, quarterly, yearly), etc. Some or all of this financial information may be provided to responsible parties as feedback to encourage improvements in transient cluster designs. In some embodiments, the execution information is associated with system capacity (e.g., computing resources) and the allocation amounts comprise allocated system capacity (e.g., in connection with minimum and maximum limits for persistent clusters, system resource allocation rules or logic, etc.).

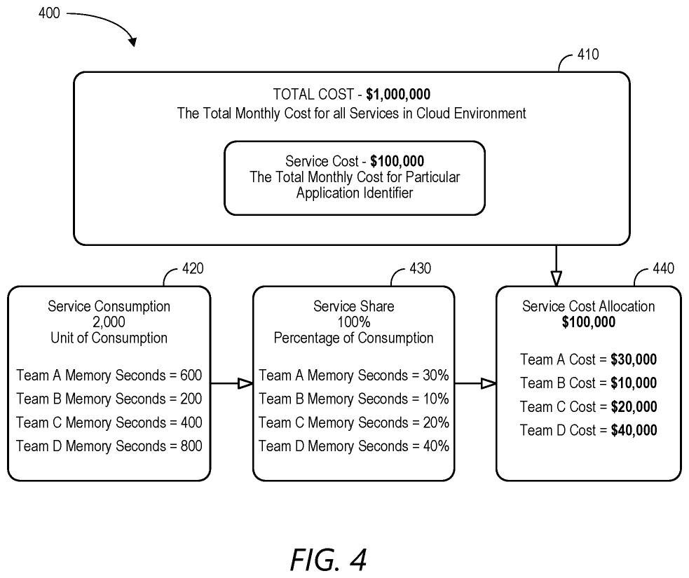

The allocation rules may be associated with calculations utilizing any type of computing resources, such as Central Processing Unit (“CPU”) resources, memory resources, data storage resources, Input Output (“IO”) resources, activity-based costing logic, etc. For example, FIG. 4 is an illustration 400 of allocation in accordance with some embodiments. A cloud service provider may provide an enterprise with total cost information 410 including a total monthly cost for all cloud services ($1,000,000) along with a monthly service cost for a particular product (e.g., $100,000 for a transient cluster associated with a specific application identifier). A cloud allocation tool may determine an overall service total for an enterprise using a unit of service consumption 420. This may then be allocated among various organizations (e.g., teams) within the enterprise. In the example of FIG. 4, the unit of consumption is memory seconds for various transient clusters rolled on a per-team basis (e.g., the overall enterprise used 2,000 memory seconds with team A using 600 memory seconds, team B using 200 memory seconds, etc.). These can be converted into a service share for each team on a percentage basis 430. For example, since team A used 600 memory seconds out of the total 2,000 memory seconds, it is assigned a 30% service share (e.g. 600/2,000*100). These percentages are then used to allocate the overall service cost for the enterprise 440 (e.g., with $30,000 or 30% of $100,000being allocated to team A, $10,000 being allocated to team B, etc.). Although FIG. 4 shows a single type of consumption unit for simplicity, embodiments may incorporate combinations of many types of consumption units in a single financial cost calculation.

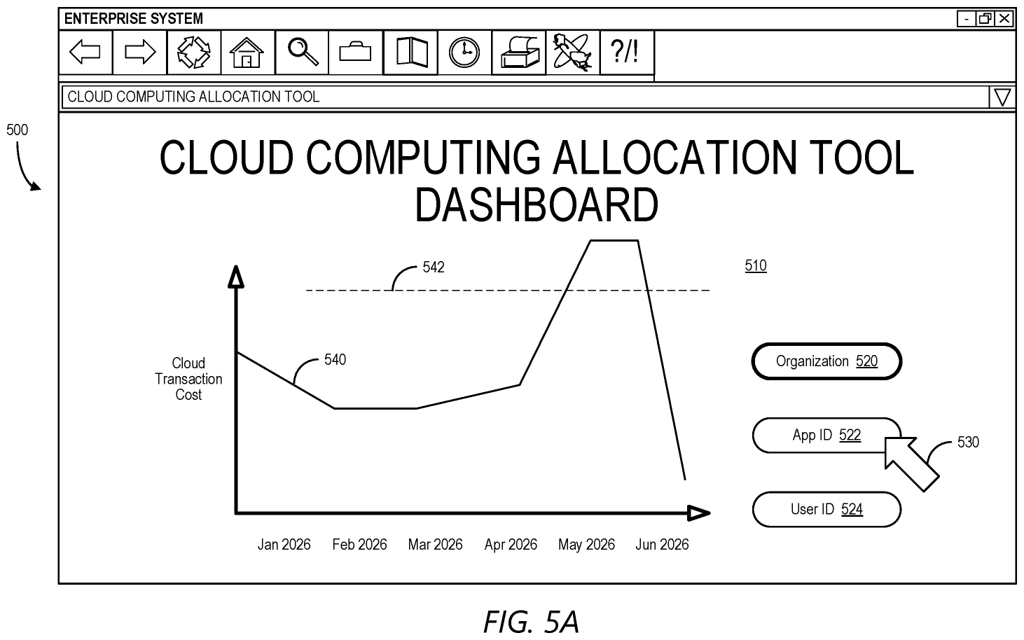

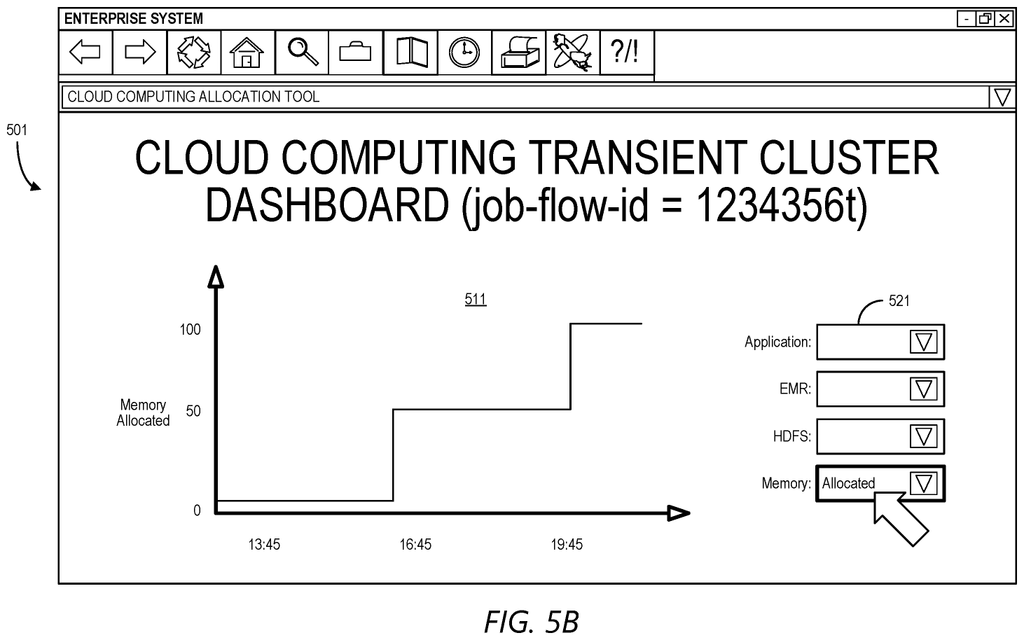

These allocations can then be displayed to responsible parties for each organization (e.g., team) to encourage improved cloud efficiency. FIG. 5A is an allocation dashboard display 500 according to some embodiments. The display 500 includes a graph 510 that may be customized based on organization 520, application identifier 522, user identifier 524, etc. (via icon selection with a computer mouse pointer 530). The graph 510 shows cloud transaction costs 540 (e.g., for an organization) over a period of time. The graph 510 might also indicate with the cloud transaction costs 540 exceed a predetermined threshold amount 542 (e.g., which may trigger an alert signal to a user associated with organization). FIG. 5B is a transient cluster display 501 according to some embodiments. The display 501 includes a graph 511 having information associated with a transient stack containing security information for a cluster, an instance profile of the cluster, the cluster itself, etc. The graph 511 may be configured 521 to display information about, for example, an application (e.g., a number of applications running, pending, failed, killed, submitted, or completed), Elastic Map Reduce (“EMR”) nodes (e.g., a total number, active nodes, unhealthy nodes, decommissioned nodes, reboot nodes, or lost nodes), Hadoop Distributed File System (“HDFS”) data (e.g., bytes written, utilization, or read), memory data (e.g., total, reserved, or allocated), containers (e.g., reserved, pending, or allocated), blocks (e.g., missing, corrupt, or under replicated) etc.

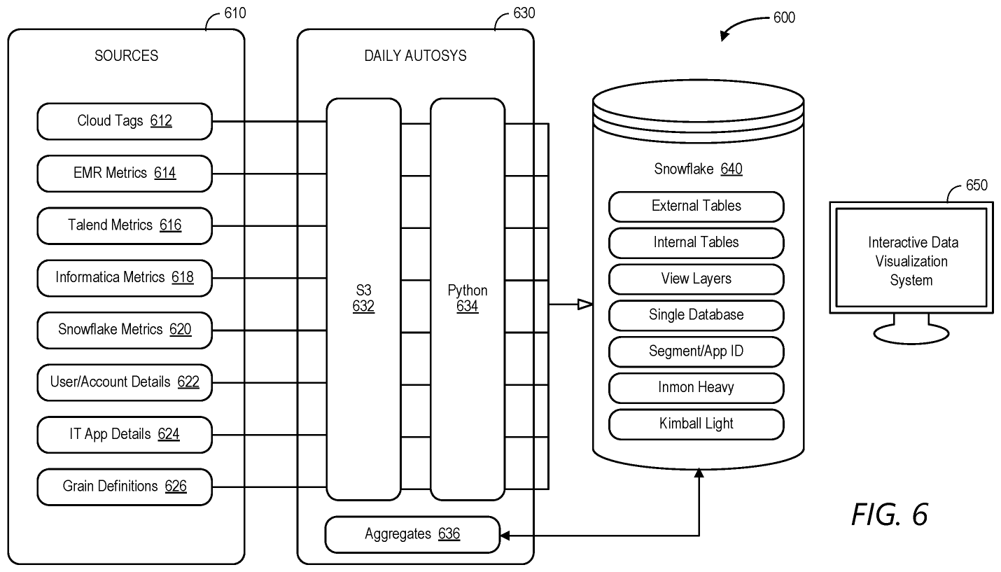

FIG. 6 is an allocation system 600 in accordance with some embodiments. The system includes sources 610, such as cloud tags 612 (e.g., from technology business management software such as APPTIO®), EMR metrics 614, Talend metrics 616, Informatica metrics 618, Snowflake metrics 620, user identifier and/or account details 622, Information Technology (“IT”) application details 624, grain definitions 626 from lookup tables, etc. Information from the sources is processed by a daily autosys 630 (e.g., via S3 632 and/or Python 634) and stored in Snowflake 640 (e.g., in external and internal tables, view layers, a single database, as a segment/application identifier, Inmon heavy data, Kimball light data, etc. An interactive data visualization system 650, such as Tableau®, may access information from Snowflake 640 for display to organizations and aggregates 636 may be provided back to the daily autosys 630.

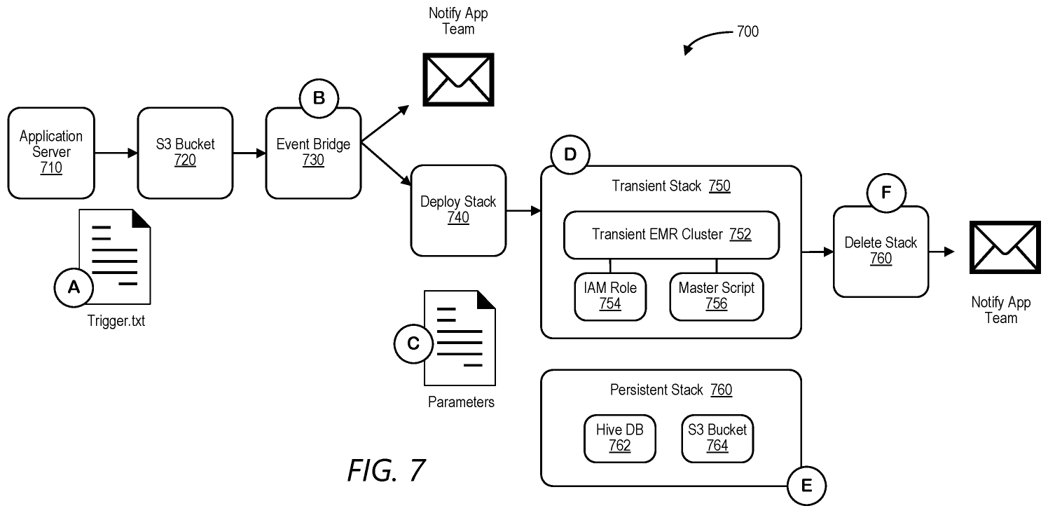

FIG. 7 is a high-level information flow overview 700 according to some embodiments. Initially, an application server 710 may send a trigger document to an S3 bucket 720. For example, at (A) an application team may upload a trigger file using a service account to a designated S3 location per application. At (B), an event bridge 730 may then automatically transmit an email notification message to an application team leader and arrange a deploy stack 740 in accordance with a parameters document at (C). For example, the event bridge 730 may launch a transient cluster as soon as the trigger file is uploaded to the S3 location. This event bridge 730 rule may comprise a service catalog product that is provisioned by an administration team for each application team that wants a transient cluster. The parameters document may comprise a Java Script Object Notation (“JSON”) file defining, for example, instance types, auto-scaling minimum and maximum values, etc.

At (D), a transient stack 750 may include a transient EMR cluster 752, an Identity and Access Management (“IAM”) role 754, a master script 756, etc. The cloud formation transient stack may be created by a Lambda function each time it is invoked (e.g., each time a job is run with the transient cluster 752). The IAM role 754 may be based on already granted IAM permissions provided to an application team's service account. The application team may deploy the master script 756 at a designated S3 location (defined in parameters file) each time the transient cluster 752 is run. The master script 756 may comprise a single set of instructions that the transient cluster 752 runs through before terminating. Once this script is completed, the transient cluster 752 terminates automatically.

If necessary, at (E) a persistent stack 760 may be created with a hive database 762 and an S3 bucket 764. The persistent stack 760 may include resources that live outside the transient cluster 752 such as data that is ingested to the application teams S3 bucket. This also includes any third-party access needed and data catalog access so the users can interact with their already existing databases and tables. The persistent stack 760 may be shared among all transient clusters 752 and will not terminate at completion of a terminal cluster 752 job.

At (F), the transient stack is deleted 760 and an email notification is automatically sent to an application team leader. Once a cluster is done executing master script 756 (that is, the jobs are complete), the cluster will auto-terminate. A Lambda function may clean up the residual of the transient stack 750 to save on cloud costs.

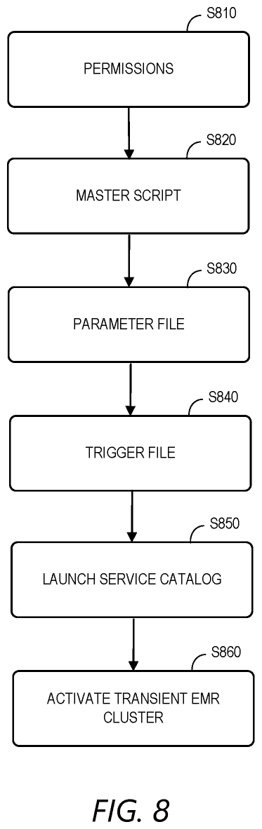

FIG. 8 is a more detailed method in accordance with some embodiments. At S810, the system may add permissions to a service account. This may involve ensuring that the application team has a service account and confirming that the service account has an IAM role (and that it is an instance role). If the IAM role is not an instance role, a role specific to the transient cluster may be re-created and the same permissions may be replicated. This instance role is what the transient cluster will use for permissions.

At S820, the system may create the master script which will be pushed to S3 for deployment you have. The destination location is defined in the parameters JSON file. A transient cluster runs a single master script then shuts itself down. The master script has the commands the cluster will execute and is run when the cluster is launched. Once the script exits, the cluster shuts itself down. This is a wrapper script that has the environment details, such as all the Python libraries to install, or sub-scripts that will be run. The script reads commands sequentially and once it is finished executing the commands in this script it will terminate the transient EMR cluster.

At S830, the system may create the parameter file. The parameter file is created prior to the first deployment and saved to Github. The parameter file drives the configuration of each individual Transient EMR cluster and is maintained in GitHub for development (and pulled from GitHub to S3 via webhook for use within the cluster). This file will be used by the Lambda function spinning up the stack needed for the transient cluster. Parameters may include an appropriate instance type, auto-scaling parameters (for the number of core nodes), a subnet identifier where instances are assigned an IP, a location where the base level of permissions are being granted for the transient cluster, etc. At S840, the system may create a trigger file needed to create the initial S3 path for the first time before launching the product. Placing the actual trigger file comes later in process.

At S850, a service catalog path may be used to launch a transient EMR. This may involve providing launch parameters in a “Launch” screen, such as product versions, an application configuration, an application name, an application identifier, a line of business, an email address for notifications, etc. At S860, the system may activate the transient EMR cluster with the trigger file. For example, the master file and trigger file may be uploaded from an edge node using a service account.

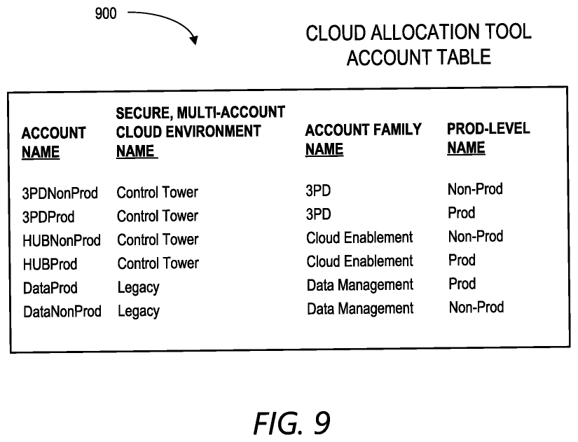

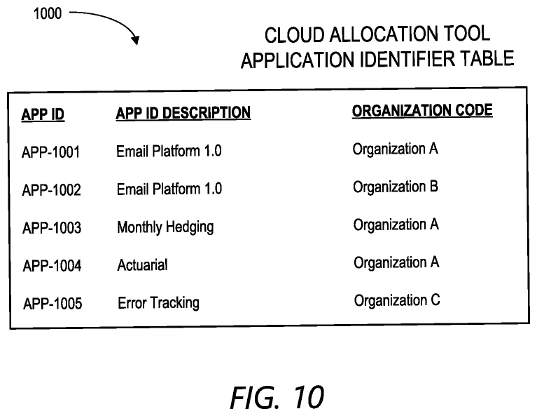

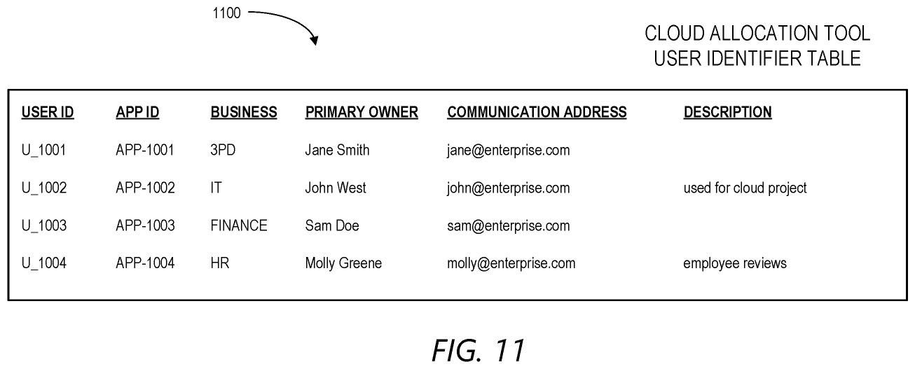

FIGS. 9 through 11 are allocation lookup tables according to some embodiments. In particular, FIG. 9 is a cloud allocation tool account table 900 including an account name, an environment name, an account family, and a production level name. FIG. 10 is a cloud allocation tool application identifier table 1000 including an application identifier, an application identifier description, and an organization code. FIG. 11 is a cloud application tool user identifier table 1100 including a user identifier, application identifier, business, primary owner, communication address, and description. The tables 900, 1000, 1100 may be associated with a spreadsheet application, such as MICROSOFT™ EXCEL®, and may be used to allocate and “rollup” financial costs associated with cloud transactions for display to relevant parties to encourage efficient cloud application development.

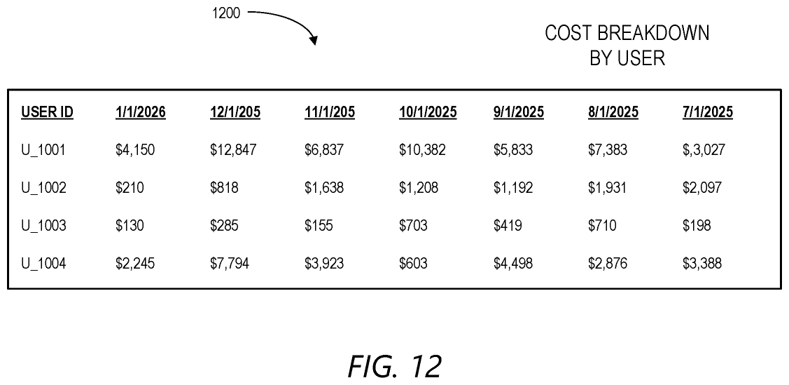

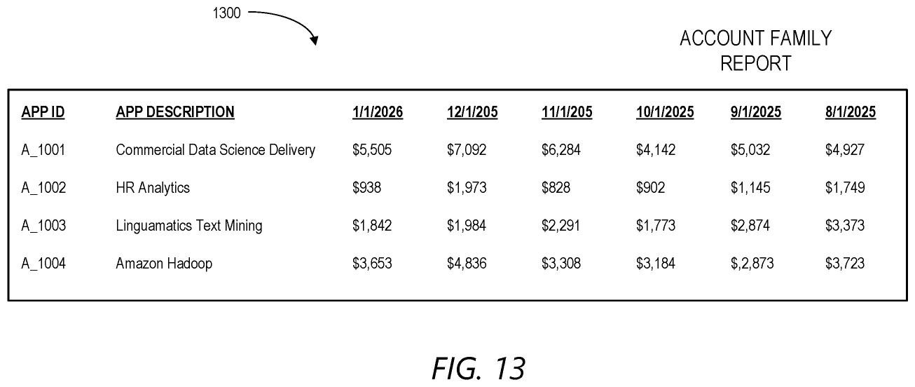

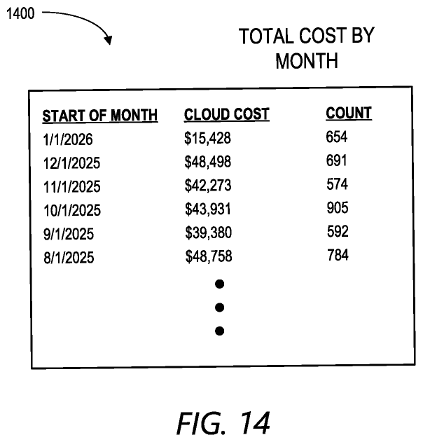

FIGS. 12 through 14 are allocation output tables in accordance with some embodiments. In particular, FIG. 12 is a cost breakdown by user output table 1200 including a user identifier and a series of time periods. Each entry in the table 1200 shows an allocated cost for that user during that time period. FIG. 13 is an account family output table 1300 including an application identifier, an application description, and a series of time periods. Each entry in the table 1300 shows an allocated cost for that application during that time period. FIG. 14 is a total cost by month output table 1400 including a start of month, a cloud cost, and an overall process count. The tables 1200, 1300, 1400 may be displayed to relevant parties (e.g., via dashboards) and may be used to encourage efficient cloud application development.

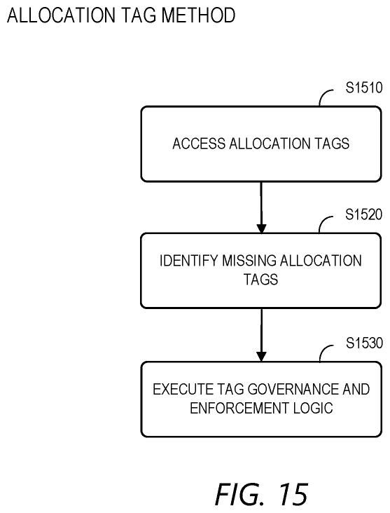

According to some embodiments, a big data workload batch processing job is associated with an allocation tag. These tags may be associated with services and hierarchies that roll up financial allocation costs correctly. A goal of this is to roll things to organization or departments in a way that changes behaviors. To do that, help low level tags roll up correctly might utilize, for example, Active Directory (“AD”) and/or PlanIT information. For example, FIG. 15 is an allocation tagging method according to some embodiments. At S1510, the system may access allocation tags. The tags may be automatically generated based on application identifiers or names, IT identifiers, an organization chart, a description, a lookup table, etc. or may be assigned manually. According to some embodiments, grouping is provided “just a bit above” application identifiers and also “just a bit below” it. At S1520, the system may identify missing tags (e.g., for new applications that have not been tagged). At S1530, tag governance and enforcement logic may be executed (e.g., to automate the enforcement of tagging standards into a service catalog). The logic might, for example, try to ensure that tags are consistently applied.

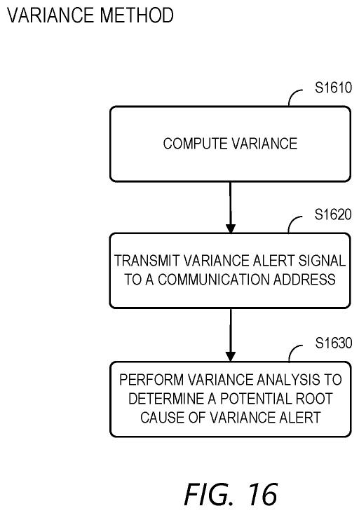

FIG. 16 is an allocation variance method in accordance with some embodiments. At S1610, the system may compute an allocation variance. At S1620, the system automatically transmits a variance alert signal to a communication address associated with an organization of the enterprise when an allocated amount exceeds a threshold (e.g., to alert organizations when infrastructure costs are going outside of boundaries so action can be taken). At S1630, the system is further to automatically perform variance analysis to determine a potential root cause of an identified variance alert (e.g., to determine the root cause of variances and tracking them for learning and future prevention).

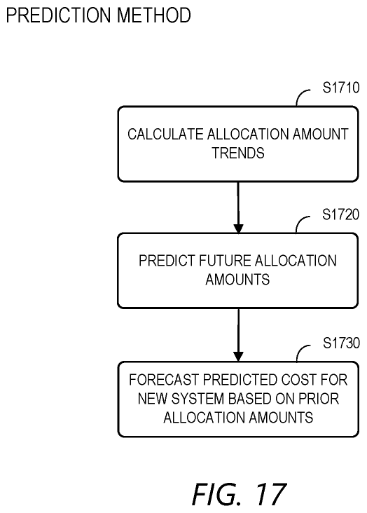

Once allocations can accurately show teams, departments, divisions, etc. their cloud service costs, trending forecasts and predictions might be. While this could be linear, in other cases it may not be, so the system may add a means of projection allowing teams to adjust accordingly. FIG. 17 is an allocation prediction method according to some embodiments. At S1710, the system may automatically calculate allocation amount trends for at least one organization within the enterprise (e.g., are the cloud costs going up, going down, following a seasonal pattern, etc.). According to some embodiments, machine learning or other artificial intelligence techniques may be used to facilitate this calculation. At S1720, the system may automatically forecast a predicted cost for at least one organization based on prior allocation amounts. At S1730, the system may forecast a predicted cost for a new system based on prior allocation amounts (e.g., what did similar cloud systems cost in the past?). After cloud service trending is in place, the system may roll that up and start making portfolio level projections. For example, with enough solutions being tracked, the system may examine any proposed new solution, identify old solutions that were similar, and extrapolate a financial cloud allocation cost. Once the system supports running many solutions and measuring them, it may be able to see anomalies (and their costs) associated with migrations, mergers and acquisitions, etc. (and when these unusual events are about to occur, the system may accurately project their costs in advance).

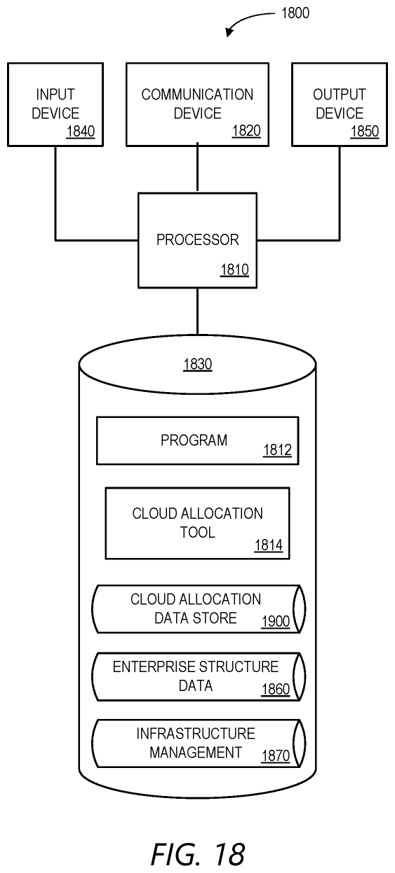

The embodiments described herein may be implemented using any number of different hardware configurations. For example, FIG. 18 illustrates an apparatus or platform 1800 that may be, for example, associated with the system 200 of FIG. 2 (or any other system described herein). The platform 1800 comprises a processor 1810, such as one or more commercially available Central Processing Units (“CPUs”) in the form of one-chip or multi-chip microprocessors, coupled to a communication device 1820 configured to communicate via a communication network (not shown in FIG. 18). The communication device 1820 may be used to communicate, for example, with one or more cloud service environment devices. The platform 1800 further includes an input device 1840 (e.g., a mouse and/or keyboard to enter organization hierarchy information or enterprise allocation logic) and an output device 1850 (e.g., a computer monitor to display automatically generated allocation reports, trend prediction, variance alerts, etc.).

The processor 1810 also communicates with a storage device 1830. The storage device 1830 may comprise any appropriate information storage device, including combinations of magnetic storage devices (e.g., a hard disk drive), optical storage devices, mobile telephones, and/or semiconductor memory devices. The storage device 1830 stores a program 1812 and/or a cloud allocation tool 1814 for controlling the processor 1810. The processor 1810 performs instructions of the programs 1812, 1814, and thereby operates in accordance with any of the embodiments described herein. For example, the processor 1810 may establish a transient infrastructure in a cloud computing environment, trigger execution of a big data workload batch processing job, run a master script, automatically shut down the transient infrastructure, and delete associated resources. The processor 1810 may receive information from a data store that contains electronic records (with each record including hierarchy information about organizations within an enterprise). The processor 1810 may also receive execution information associated with the big data workload batch processing job that was executed by the cloud computing environment for the enterprise. Based on the received execution information, hierarchy information about organizations within the enterprise, and allocation rules, the processor 1810 may automatically calculate allocation amounts for the execution information among a plurality of the organizations.

The programs 1812, 1814 may be stored in a compressed, uncompiled and/or encrypted format. The programs 1812, 1814 may furthermore include other program elements, such as an operating system, a data store management system, and/or device drivers used by the processor 1810 to interface with peripheral devices.

As used herein, information may be “received” by or “transmitted” to, for example: (i) the platform 1800 from another device; or (ii) a software application or module within the platform 1800 from another software application, module, or any other source.

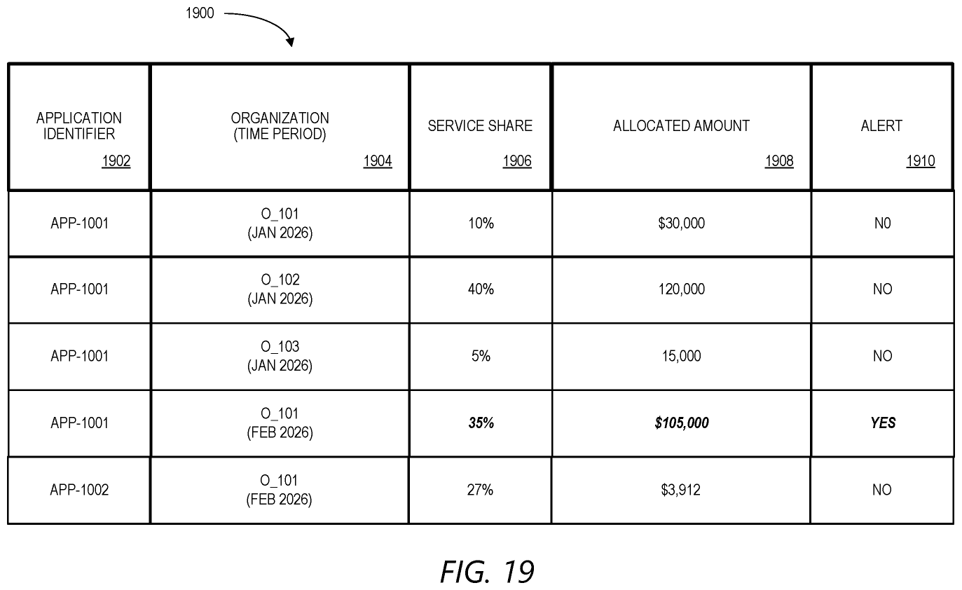

In some embodiments (such as shown in FIG. 18), the storage device 1830 stores enterprise structure data 1860 (e.g., to roll up cloud service allocation costs), infrastructure management data 1870 (e.g., to automatically start and delete services on an as-needed basis), and cloud allocation data store 1900. An example of a data store that may be used in connection with the platform 1800 will now be described in detail with respect to FIG. 19. Note that the data store described herein is only one example, and additional and/or different information may be stored therein. Moreover, various data stores might be split or combined in accordance with any of the embodiments described herein.

Referring to FIG. 19, a table is shown that represents the cloud allocation data store 1900 that may be stored at the platform 1800 according to some embodiments. The table may include, for example, entries identifying application costs being tracked and allocated by the system. The table may also define fields 1902, 1904, 1906, 1908, 1910 for each of the entries. The fields 1902, 1904, 1906, 1908, 1910, may, according to some embodiments, specify: an application identifier 1902, an organization and time period 1904, a service share 1906, an allocated amount 1908, and an alert 1910. The information in the cloud allocation data store 1900 may be created and updated, for example, when application execution information is received from a cloud service provider.

The application identifier 1902 may be, for example, a unique alphanumeric code identifying a cloud service being executed for an enterprise (e.g., a big data workload batch processing job executed by a transient cluster). The organization and time period 1904 may indicate which organization of the enterprise initiated the cloud service (with the time period being used to summarize dashboard displays, output tables, etc.). The service share 1906 might indicate an amount of computing resources that were consumed by execution of that application for that organization. The allocated amount 1908 may represent a financial cost calculated based on the service share 1906 and an overall cloud service cost from a cloud service provider. The alert 1910 might indicate if the allocated amount 1908 exceeds some pre-arranged boundary condition.

Thus, some embodiments may provide improved organization-based cloud service and cost allocations for an enterprise. This may help keep costs down and allocate costs precisely (as well as project cloud costs accurately into the future). Embodiments may help ensure that the cloud environment does not cost more than needed, that those costs can be shown and/or charged back to the consuming areas so that the enterprise can federate the incentives to control costs (and see shifts in cost that are coming well in advance). Costs may be considered from the point of work intake, and automate as much cost management as possible, to report those costs clearly and accurately, to integrate the costs directly into enterprise budget processes, and to anticipate costs into the reasonable future. In some embodiments, an owner chargeback may be arranged based on allocation amounts to charge costs directly to the budget of service consumers based on service use.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

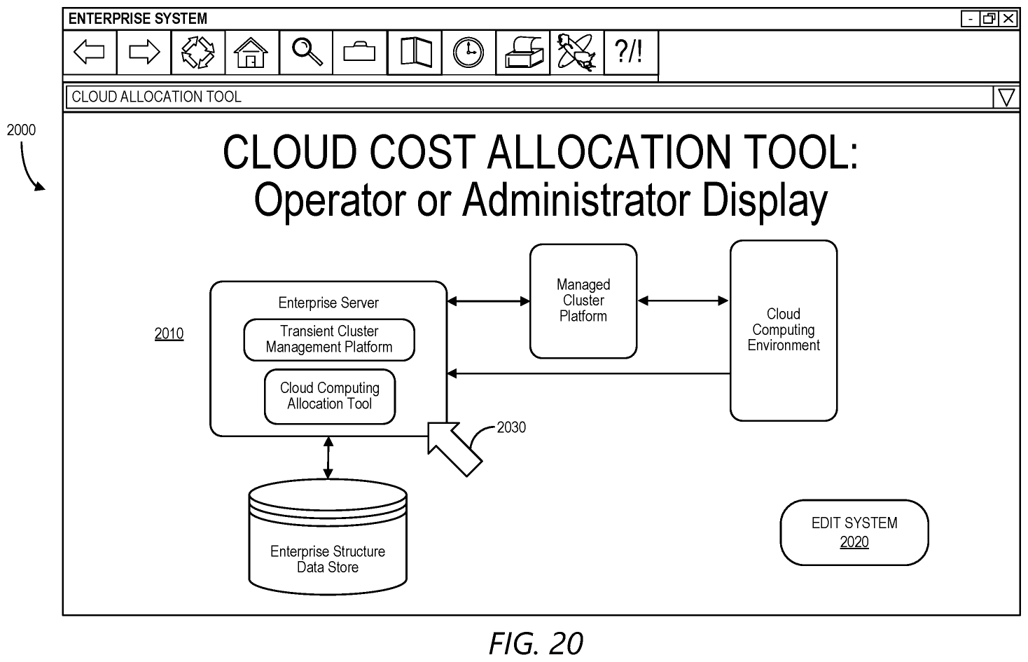

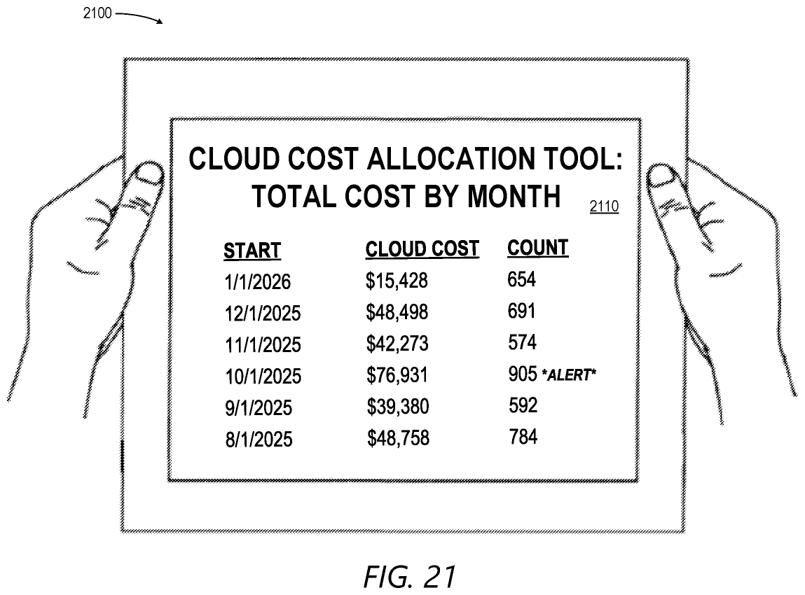

Although specific hardware and data configurations have been described herein, note that any number of other configurations may be provided in accordance with embodiments of the present invention (e.g., some of the information associated with the data stores described herein may be combined or stored in external systems). Note that the displays and devices illustrated herein are only provided as examples, and embodiments may be associated with any other types of interfaces. For example, FIG. 20 is an administrator or operator display 2000 including graphical representations of elements 2010 of a cloud cost allocation tool. Selection of a portion or element of the display 2000 might result in the presentation of additional information about that portion or device (e.g., a popup window presenting a more detailed view of data mappings, allocation rules, communication addresses for organizations, or other specifics of the system implementation) or let an operator or administrator enter or annotate additional information about the cost allocation processing system (e.g., based on root cause recommendations from a ML model). Selection of an “Edit System” icon 2020 (e.g., by touchscreen or computer mouse pointer 2030) might cause the system or platform to save changes, transmit an allocation report or forecast, etc. According to some embodiments a warning signal or alert may be automatically transmitted to a communication device (e.g., associated with a manager) when a value moves beyond a threshold (e.g., when a predicted trend exceeds expectations). Similarly, FIG. 21 illustrates a handheld tablet 2100 display 2110 in accordance with some embodiments. The display 2110 includes a graphical representation of a total allocated cost by month output table. The display 2110 might be used, for example, to improve cloud service design for an enterprise. Note that embodiments might be associated with any type of business (e.g., insurance companies, financial enterprises, educational enterprises, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A system associated with an enterprise utilizing a cloud computing environment, comprising:
(a) a transient infrastructure management platform to establish a transient infrastructure in the cloud computing environment, trigger execution of a big data workload batch processing job, and run a master script, wherein the transient infrastructure associated resources are automatically deleted;
(b) an enterprise structure data store containing electronic records, each record including hierarchy information about organizations within the enterprise;
(c) a cloud computing allocation tool, coupled to the enterprise structure data store, including:
a computer processor for executing program instructions; and
a memory, coupled to the computer processor, storing program instructions that, when executed by the computer processor, cause the cloud computing allocation tool to:
receive execution information associated with the big data workload batch processing job that was executed by the cloud computing environment for the enterprise, and
based on the received execution information, hierarchy information about organizations within the enterprise, and allocation rules, automatically calculate allocation amounts for the execution information among a plurality of the organizations; and
(d) a communication port coupled to the cloud computing allocation tool to provide a graphical interactive user interface display via a distributed communication network, the graphical interactive user interface including the allocation amounts.

2. The system of claim 1, wherein the big data workload batch processing job is associated with at least one of: (i) a managed cluster platform, (ii) a managed, cloud-based data storage and analysis platform, (iii) an infrastructure support ticketing system, (iv) a third-party data service, (v) an on-premises platform, (vi) an enterprise cloud data management and data integration platform, and (vii) an end-to-end data management platform.

3. The system of claim 1, wherein the execution information includes a financial cost, the computed allocation amounts comprise allocated financial costs and the system is further to display a combined financial cost for at least one of: (i) a subset of the organizations, and (ii) a period of time.

4. The system of claim 1, wherein the execution information is associated with system capacity and the allocation amounts comprise allocated system capacity.

5. The system of claim 1, wherein the allocation rules are associated with at least one of: (i) an account identifier, (ii) an application identifier, and (iii) a user identifier.

6. The system of claim 1, wherein the allocation rules are associated with at least one of: (i) Central Processing Unit (“CPU”) resources, (ii) memory resources, (iii) data storage resources, (iv) Input Output (“IO”) resources, and (v) activity-based costing logic.

7. The system of claim 1, wherein the big data workload batch processing job is associated with an allocation tag.

8. The system of claim 7, wherein the system is further to execute tag governance and enforcement logic.

9. The system of claim 1, wherein the system is further to automatically transmit a variance alert signal to a communication address associated with an organization when an allocated amount exceeds a threshold.

10. The system of claim 9, wherein the system is further to automatically perform variance analysis to determine a potential root cause of an identified variance alert.

11. The system of claim 1, wherein the system is further to automatically calculate allocation amount trends for at least one organization.

12. The system of claim 1, wherein the system is further to automatically forecast a predicted cost for at least one organization based on prior allocation amounts.

13. A computer-implemented method associated with an enterprise utilizing a cloud computing environment, comprising:
establishing, by a transient infrastructure management platform, a transient infrastructure in the cloud computing environment;
triggering execution of a big data workload batch processing job;
running, by the transient cluster management platform, a master script;
automatically shutting down the transient cluster and deleting associated resources;
retrieving, by a computer processor of a cloud computing allocation tool, hierarchy information from an enterprise structure data store containing electronic records, each record including hierarchy information about organizations within the enterprise;
receiving execution information associated with the big data workload batch processing job that was executed by the cloud computing environment for the enterprise;
based on the received execution information, hierarchy information about organizations within the enterprise, and allocation rules, automatically calculating allocation amounts for the execution information among a plurality of the organizations; and
transmitting, via a communication port coupled to the cloud computing allocation tool, data to provide a graphical interactive user interface display via a distributed communication network, the graphical interactive user interface including the allocation amounts.

14. The method of claim 13, wherein the big data workload batch processing job is associated with at least one of: (i) a managed cluster platform, (ii) a managed, cloud-based data storage and analysis platform, (iii) an infrastructure support ticketing system, (iv) a third-party data service, (v) an on-premises platform, (vi) an enterprise cloud data management and data integration platform, and (vii) an end-to-end data management platform.

15. The method of claim 13, wherein the execution information includes a financial cost and the computed allocation amounts comprise allocated financial costs.

16. The method of claim 15, further comprising:
displaying a combined financial cost for at least one of: (i) a subset of the organizations, and (ii) a period of time.

17. The method of claim 13, wherein the allocation rules are associated with at least one of: (i) an account identifier, (ii) an application identifier, and (iii) a user identifier.

18. The method of claim 13, wherein the allocation rules are associated with at least one of: (i) Central Processing Unit (“CPU”) resources, (ii) memory resources, (iii) data storage resources, (iv) Input Output (“IO”) resources, and (v) activity-based costing logic.

19. A non-transitory computer-readable medium storing instructions adapted to be executed by a computer processor to perform a method associated with an enterprise utilizing a cloud computing environment, the method comprising:
establishing, by a transient infrastructure management platform, a transient infrastructure in the cloud computing environment;
triggering execution of a big data workload batch processing job;
running, by the transient cluster management platform, a master script;
automatically shutting down the transient cluster and deleting associated resources;
retrieving, by a computer processor of a cloud computing allocation tool, hierarchy information from an enterprise structure data store containing electronic records, each record including hierarchy information about organizations within the enterprise;
receiving execution information associated with the big data workload batch processing job that was executed by the cloud computing environment for the enterprise;
based on the received execution information, hierarchy information about organizations within the enterprise, and allocation rules, automatically calculating allocation amounts for the execution information among a plurality of the organizations; and
transmitting, via a communication port coupled to the cloud computing allocation tool, data to provide a graphical interactive user interface display via a distributed communication network, the graphical interactive user interface including the allocation amounts.

20. The medium of claim 19, wherein the big data workload batch processing job is associated with an allocation tag and further comprising:
executing tag governance and enforcement logic.

21. The medium of claim 19, further comprising:
automatically transmitting a variance alert signal to a communication address associated with an organization when an allocated amount exceeds a threshold; and
automatically performing variance analysis to determine a potential root cause of an identified variance alert.

22. The medium of claim 19, further comprising:
automatically calculating allocation amount trends for at least one organization; and
automatically forecasting a predicted cost for at least one organization based on prior allocation amounts.
